(19) United States
(12) Patent Application Publication
(10) Pub. No.: US 2026/0094774 A1
(43) Pub. Date: Apr. 2, 2026

(54) DRIVING MECHANISM AND OPERATING DEVICE FOR AN ELECTRICAL SWITCH

(71) Applicant: Eaton Intelligent Power Limited, Dublin (IE)

(72) Inventor: Samuel T. Reed, Washington Island, WI (US)

(21) Appl. No.: 19/338,493

(22) Filed: Sep. 24, 2025

Related U.S. Application Data
(60) Provisional application No. 63/701,769, filed on Oct. 1, 2024.

(51) Int. Cl. H01H 3/46; H01H 3/38; H01H 33/666; H01H 3/30

(52) U.S. Cl. CPC H01H 3/46; H01H 3/38; H01H 33/6664; H01H 2003/3073

(57) ABSTRACT

A system includes: a base; an actuator mounted to the base, the actuator including an output configured to move along a linear path relative to the base; a driving apparatus coupled to the output; and a crank apparatus including at least one crank device, the at least one crank device including: a fixed pivot point attached to the base, a moveable pivot point attached to the driving apparatus, and a connection point attached to a switch operating device. The at least one crank device rotates about the fixed pivot and the moveable pivot moves the driving apparatus relative to the base in response to the output moving along the linear path to control the switch operating device to perform one of an open operation and a close operation in a switch.

### CROSS-REFERENCE TO RELATED APPLICATION

This application claims priority to U.S. Provisional Application 63/701,769, filed October 1, 2024 and titled DRIVING MECHANISM AND OPERATING DEVICE FOR AN ELECTRICAL SWITCH, which is incorporated herein by reference in its entirety.

### TECHNICAL FIELD

This disclosure relates to a driving mechanism and an operating device for an electrical switch.

### BACKGROUND

An electrical assembly (for example, a circuit breaker or a vacuum fault interrupter) may be mounted in a fluid-filled housing.

### SUMMARY

In one aspect, a system includes: a base; an actuator mounted to the base, the actuator including an output configured to move along a linear path relative to the base; a driving apparatus coupled to the output; and a crank apparatus including at least one crank device, the at least one crank device including: a fixed pivot point attached to the base, a moveable pivot point attached to the driving apparatus, and a connection point attached to a switch operating device. The at least one crank device rotates about the fixed pivot and the moveable pivot moves the driving apparatus relative to the base in response to the output moving along the linear path to control the switch operating device to perform one of an open operation and a close operation in a switch.

Implementations may include one or more of the following features.

The actuator may be a permanent magnet actuator. The permanent magnet actuator may include a housing that is mounted to the base and encloses a permanent magnet; and the output may be accessible from an exterior of the housing. The permanent magnet actuator may include a neodymium magnet. The permanent magnet actuator may include a magnetic material configured for operation at temperatures between -40 degrees Celsius and 140 degrees Celsius.

The system also may include a linear transducer configured for operation at temperatures between -40 degrees Celsius and 140 degrees Celsius. A first end of the linear transducer may be fixedly attached to the base and a second end of the linear transducer may move with the driving apparatus, and the linear transducer may provide an indication of a position of the driving apparatus.

The system also may include the switch. The switch may be a vacuum interrupter, and the switch operating device may include a moveable operating rod coupled to a moveable electrical contact of the vacuum interrupter.

The system also may include an operating rod housing that includes an interior space, the switch operating device may extend through a first end of the operating rod housing and into the interior space, and a second end of the operating rod housing may define one or more fluid passageways configure to allow fluid flow between the interior space and a region exterior to the operating rod housing. The system also may include a contact pressure spring in the interior space, and the contact pressure spring may surround a portion of the switch operating device. The operating rod housing also may include: an insert including a wall at a first end and an open second end; and an end block received in the open second end, the end block including a first side that faces the first end and a second side that faces away from the first end. In these implementations, the one or more fluid passageways are openings that extend between the first side of the end block and the second side of the end block, and the contact pressure spring is between the wall and the first side of the end block.

The system also may include an operating rod housing including an interior space and a flexible guide bushing, the switch operating device may extend through the interior space and the flexible guide bushing surrounds the switch operating device, and the flexible guide bushing may include one or more openings that allow fluid flow.

The crank apparatus may include a plurality of crank devices that rotate simultaneously about their respective pivot points in response to the output moving along the linear path.

In another aspect, an operating rod assembly includes: a housing that includes an open end; an insert in the open end, the insert including: a first wall at a first end, a second wall at a second end; and a compressible element in a space between the first wall and the second wall; and an operating rod configured to be mechanically coupled to a moving contact of a vacuum interrupter. The second wall includes one or more openings that allow fluid flow between the space and a region exterior to the housing.

The insert may include: a first piece including the first wall; and a second piece received in the first piece, and a side of the second piece may form the second wall.

In another aspect, a transformer apparatus includes: a housing including an interior region configured to receive an electrically insulating fluid; a switch in the interior region; a switch operating device in the interior region, the switch operating device including: one or more openings that fluidly couple the interior region of the housing to an interior region of the switch operating device; and a compressible element in the interior region of the switch operating device. The transformer apparatus also includes an operating apparatus including: a base;

a permanent magnet actuator mounted to the base, the permanent magnet actuator including an output configured to move along a linear path relative to the base; a driving apparatus coupled to the output; and a crank apparatus including at least one crank device, the at least one crank device including: a fixed pivot point attached to the base, a moveable pivot point attached to the driving apparatus, and a connection point attached to the switch operating device. The at least one crank device rotates about the fixed pivot and the moveable pivot moves the driving apparatus relative to the base in response to the output moving along the linear path to control the switch operating device to perform one of an open operation and a close operation in the switch.

The switch may be a vacuum fault interrupter.

Implementations of any of the techniques described herein may include a system, an apparatus, or a method. The details of one or more implementations are set forth in the accompanying drawings and the description below. Other features will be apparent from the description and drawings, and from the claims.

### DRAWING DESCRIPTION

FIG. 1 is a block diagram of an electrical distribution system.

FIGS. 2A and 2B are block diagrams of an electrical system that includes a vacuum interrupter.

FIG. 2C is a block diagram of a permanent magnet actuator.

FIG. 3 is a perspective view of an electrical system.

FIG. 4 is a cross-sectional view of the electrical system of FIG. 3.

FIG. 5 is a cross-sectional view of part of the electrical system of FIG. 3.

FIG. 6 is a cross-sectional view of the electrical system of FIG. 3 enclosed in a fluidly sealed housing.

FIG. 7A is a partial exterior perspective view of an end of a switch operating device.

FIG. 7B is a cross-sectional view of the switch operating device of FIG. 7A in the Y-Z plane.

FIG. 8 is a cross-sectional view of a system that includes a vacuum interrupter.

### DETAILED DESCRIPTION

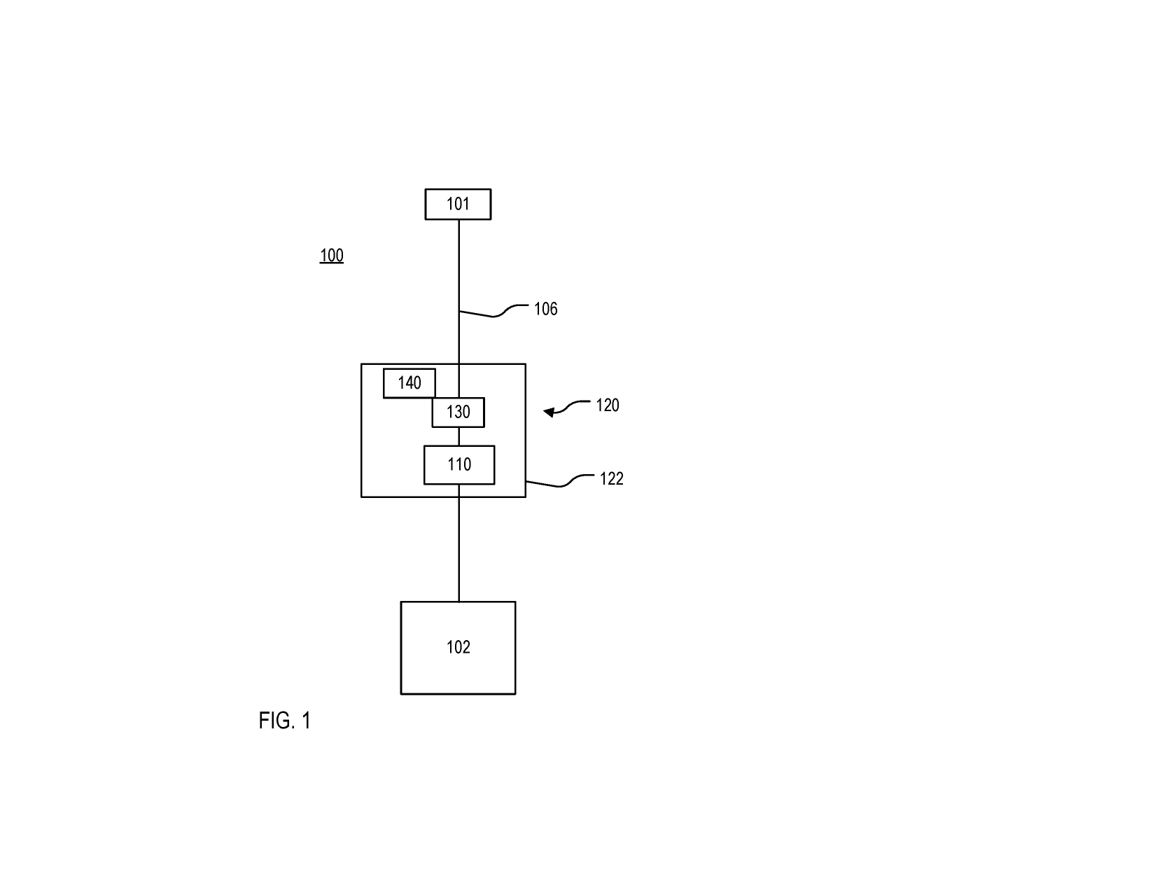

FIG. 1 is a block diagram of an electrical distribution system 100. The electrical distribution system 100 delivers electricity from a source 101 to a load 102 via a distribution path 106 and an electrical system 120. The electrical system 120 may be, for example, a transformer, a voltage regulator, a recloser, or switchgear. The electrical system 120 includes a switch 110 that has an opened state and a closed state. The state of the switch 110 determines whether the load 102 and the source 101 are electrically connected. In the opened state, electrical current cannot flow through the switch 110 and the load 102 is electrically isolated from the source 101. In the closed state, electrical current can flow through the switch 110 and the load 102 is electrically connected to the source 101. The state of the switch 110 is controlled by a switch operating device 130, which is driven by a driving system 140.

The system 120 is configured for use in high-temperature environments. For example, the driving system 140, the switch operating device 130, and/or the switch 110 may be designed for use and operation at temperatures between -40 degrees (º) Celsius (C) to 140º C or at temperatures between -40ºC and 120ºC. Additionally, the switch operating device 130 may be configured for use in an electrically insulating fluid, such as, for example, transformer or switchgear oil, mineral oil, or ester-based liquids. In these implementations, the electrical system 120 includes a fluidly sealed housing 122 that contains the electrically insulating fluid, and the switch operating device 130 and the switch 110 are submersed in the fluid.

Before discussing the driving system 140 and the switch operating device 130 in more detail, an overview of the system 100 is provided. The switch 110 may be rated for voltages between, for example, 15 kilovolts (kV) and 38 kV, or up to 38 kV. The switch 110 may be rated for continuous current of, for example, between 0 amperes (A) and 900 A, or up to 1200 A. The switch 110 may be capable of interrupting fault currents of, for example, up to 25 kiloamps (kA) root-mean-square (RMS) Symmetrical current.

The switch 110 is any type of switch that is capable of opening and closing repeatedly under the control of the driving system 140 and the switch operating device 130. For example, the switch 110 may be a vacuum interrupter (or vacuum fault interrupter), a circuit breaker, a recloser, or a contactor. The electrical system 120 is any type of system that controls and/or modifies electricity. For example, the electrical system 120 may be a vacuum fault interrupter (VFI) transformer, breaker, a recloser, or switchgear. The electrical system 120 may be a multi-phase system (for example, a three-phase system) or a single-phase system. In implementations in which the electrical system 120 is a multi-phase system, the electrical system 120 includes one switch 110 and one switch operating device 130 for each phase and a single driving system 140 that drives all of the switch operating devices 130 such that switches 110 are operated simultaneously in a ganged manner.

The distribution path 106 may include, for example, one or more distribution lines, electrical cables, and/or any other mechanism for transmitting electricity. The electrical power distribution system 100 may be, for example, an electrical grid, an electrical system, or a multi-phase electrical network that provides electricity to commercial, industrial, and/or residential customers. The electrical power distribution system 100 may have an operating voltage of, for example, at least 1 kV, up to 34.5 kV, up to 38 kV. The electrical power distribution system 100 is an alternating current (AC) electrical network and may operate at a fundamental frequency of, for example, 50 to 60 Hertz (Hz).

The electrical load 102 is any device or devices that utilizes electricity. The electrical load 102 may include, for example, transformers, switchgear, energy storage systems, computer and communication equipment, lighting, heating and air conditioning systems, motors and electrical machinery, and/or electrical appliances. The power source 101 is any source of electricity such as, for example, a power plant that generates electricity from fossil fuel or from thermal energy, or an electrical substation. The power source 101 may include one or more distributed energy resources, such as, for example, a solar energy system that includes an array of photovoltaic (PV) devices that convert sunlight into electricity or a wind-based energy system. More than one power source may supply electricity to the distribution system 100, and more than one type of power source may supply electricity to distribution system 100. The power source 101 may be a node in a larger electrical grid.

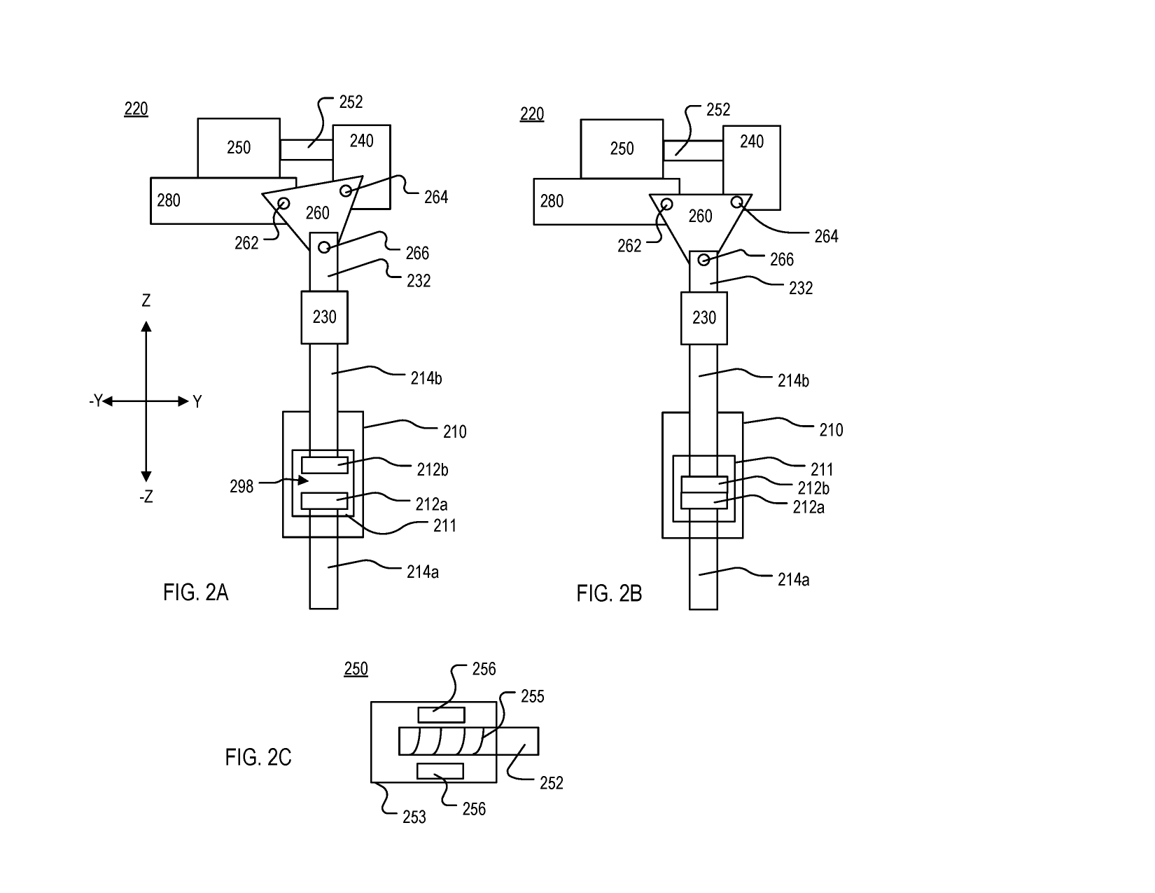

FIGS. 2A and 2B are block diagrams of an electrical system 220 that includes a vacuum interrupter 210. FIG. 2A shows the electrical system 220 with the vacuum interrupter 210 in an opened state, and FIG. 2B shows the electrical system 220 with the vacuum interrupter 210 in a closed state. The vacuum interrupter 210 includes a stationary contact 212a and a moveable contact 212b enclosed in a vacuum bottle 211. The space inside the vacuum bottle 211 is evacuated such that the contacts 212a and 212b are in an evacuated space or a vacuum environment.

The contact 212a is at an end of a stationary rod 214a, and the moveable contact 212b is at an end of a moveable rod 214b. The contacts 212a and 212b and the rods 214a and 214b are made of an electrically conductive material such as, for example, copper, brass, tin, silver, gold, or a combination of such materials. When the contacts 212a and 212b are physically separated by a gap 298 (such as shown in FIG. 2A), current cannot flow through the vacuum interrupter 210 and the vacuum interrupter 210 is in the opened state. When the contacts 212a and 212b are in physical contact (such as shown in FIG. 2B), current may flow through the vacuum interrupter 210 and the vacuum interrupter 210 is in the closed state.

The moveable rod 214a is coupled to a switch operating device 230, which couples an operating rod 232 to the moveable rod 214a. The operating rod 232 is coupled to a crank apparatus 260 at a connection point 266. The crank apparatus 260 may be, for example, a bell crank. The connection point 266 may be, for example, a post or other feature that extends from the crank apparatus 260 along the X direction (out of the page in FIGS. 2A and 2B) and is received in an opening in the operating rod 232. The crank apparatus 260 is attached to a base 280 at a fixed pivot point 262 and to a driving apparatus 240 at a moveable pivot point 264. The base 280 is a rigid and sturdy structure. For example, the base 280 may be a metal or hardened polymer frame. The driving apparatus 240 is a rigid or substantially rigid body. For example, the driving apparatus 240 may include a metal plate and/or a metal bar. The crank apparatus 260 can rotate about the fixed pivot point 262 in the Y-Z plane, but the pivot point 262 is fixed and does not move relative to the base 280. The moveable pivot point 264 is not attached to the base 280. The crank apparatus 260 can rotate in the Y-Z plane about the moveable pivot point 264 relative to the driving apparatus 240, and the moveable pivot point 264 can move relative to the base 280.

The electrical system 220 also includes an actuator 250 that has an output 252 coupled to the driving apparatus 240. The output 252 moves linearly in the +/- Y direction in response to the action of the actuator 250. The actuator 250 is a permanent magnet actuator capable of operating under a wide temperature range and at relatively high temperatures. For example, the actuator 250 may be configured for operation at temperatures between -40º C and 140º C or at temperatures up to 140ºC. Referring also to FIG. 2C, the actuator 250 includes a body 253, the output 252, a coil 255 that surrounds the output 252, and permanent magnet(s) 256 in the body 253. The output 252 also may be referred to as an armature or plunger. To move the output 252, electrical energy is applied to the coil 255, creating a temporary magnetic field that interacts with the permanent magnet 256. The interaction between the temporary magnetic field and the permanent magnet 256 moves the output 252 linearly (in the +/-Y direction in the example shown). The actuator 250 is made of materials configured for use at temperatures between -40º C and 140º C. For example, the coil 255 may be high-temperature enameled wire and the permanent magnet 256 may be neodymium.

FIG. 2A shows the electrical system 220 with the vacuum interrupter 210 in the opened state with the output 252 of the actuator 250 in a first position. To transition the vacuum interrupter 210 to the closed state (FIG. 2B), electrical current is provided to the coil 255, generating a magnetic field in the body 253 and pushing the output 252 in the Y direction to a second position. The linear motion of the output 252 also moves the driving apparatus 240 in the Y direction relative to the base 280. The motion of the driving apparatus 240 rotates the crank apparatus 260 clockwise in the Y-Z plane about the fixed pivot point 262, pushing the connection point 266 in the -Z direction and moving the operating rod 232 in the -Z direction. The moving operating rod 232 causes the moveable contact 212a to move in the -Z direction until joining the stationary contact 212b, thereby closing the vacuum interrupter 210. The output 252 of the actuator 250 is in the second position when the vacuum interrupter 210 is closed.

To transition the vacuum interrupter 210 from the closed state (FIG. 2B) to the opened state (FIG. 2A), the actuator 250 is controlled such that the output 252 moves in the -Y direction. The linear motion of the output 252 in the -Y direction moves the driving apparatus 240 in the -Y direction, causing the crank apparatus 260 to rotate in the Y-Z plane about the fixed pivot point 262 in the counterclockwise direction, and pulling the operating rod 232 upward in the Z direction. The motion of the operating rod 232 in the Z direction moves the moveable contact 212a in the Z direction and separates the contacts 212a and 212b by the gap 298. The vacuum interrupter is in the opened state and the output 252 is again in the first position.

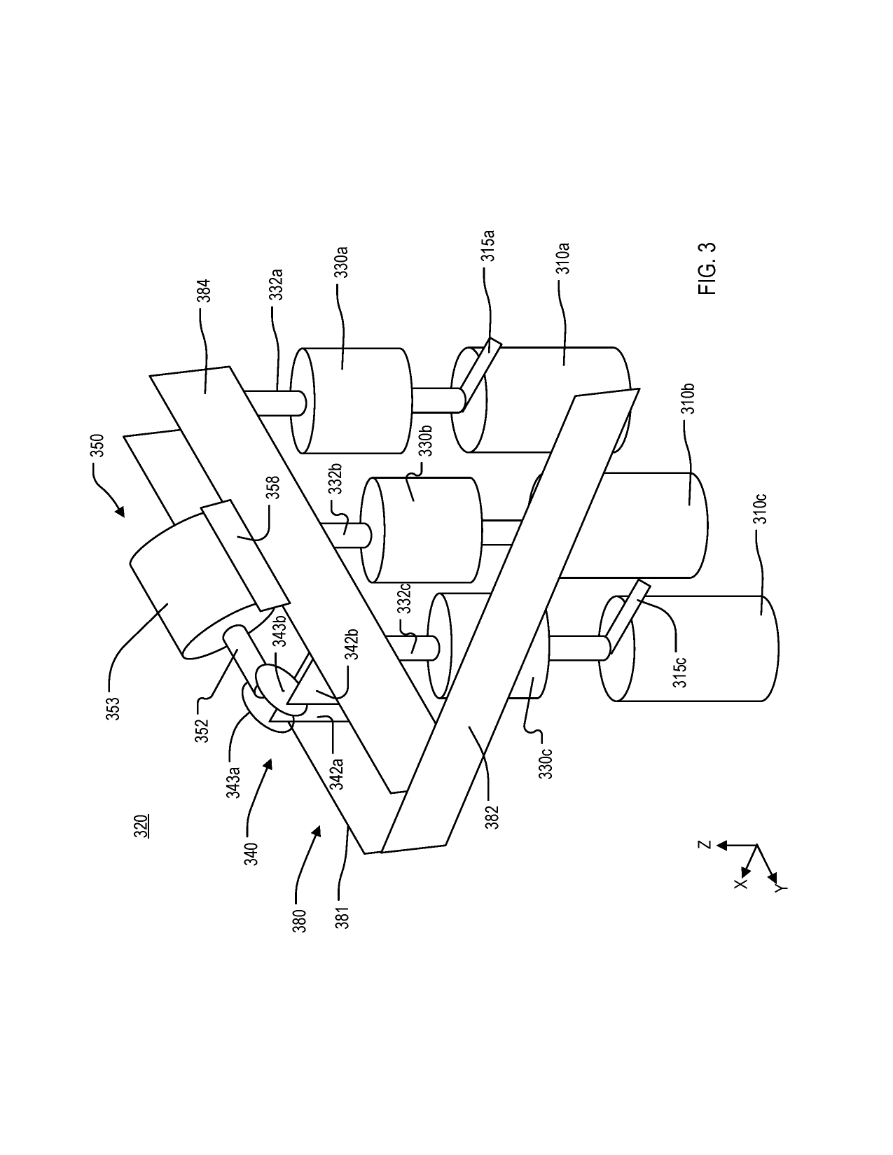

FIG. 3 is a perspective view of another electrical system 320. The electrical system 320 is a three-phase system. The electrical system 320 may be placed in an interior of a housing that may (but does not necessarily) contain transformer oil or another electrically insulating fluid. The electrical system 320 may be part of a vacuum fault interrupter (VFI) transformer.

The electrical system 320 includes a frame 380 made of a sturdy, rigid material such as metal. The frame 380 includes main portions 381 and 384, which extend in the Y-Z plane, and a side portion 382, which extends in the X-Z plane. The side portion 382 may include one or more connection flanges or other mounting points to secure the electrical system to an interior of a housing or to another structure. The main portions 381 and 384 support various other components of the electrical system 320, including a permanent magnetic actuator 350.

The electrical system 320 also includes vacuum interrupters 310a, 310b, 310c, each of which have a respective electrical terminal 315a, 315b (not shown), 315c and switch operating device 330a, 330b, 330c. The switch operating devices 330a, 330b, 330c are driven by a driving apparatus 340 to open and close the vacuum interrupters 310a, 310b, 310c.

The magnetic actuator 350 is secured in an actuator bracket 358 that is attached to the main portions 381 and 384 of the frame 380. The actuator 350 includes an output 352 that moves along a linear path in response to operation of the actuator 350. In the example shown, the linear path of the output 352 is along the Y axis. In other words, the output 352 moves in the Y direction or -Y direction relative to the main portions 381 and 384 in response to operation of the actuator 350.

The driving apparatus 340 includes parallel mechanical linkages 343a, 343b and plates 342a, 342b that extend in the Y-Z plane. The output 352 is attached to and between the two parallel mechanical linkages 343a, 343b. Each linkage 343a, 343b is attached to one of the parallel plate-like structures 342a, 342b. The linkages 343a, 343b and the plates 342a, 342b form a rigid body that may be supported by the frame 380 but is not fixedly attached to the frame 380. In this way, the linkages 343a, 343b and the plates 342a, 342b can move together linearly in the Y direction and -Y direction relative to the main portions 381 and 384.

Other implementations are possible. For example, the frame 380 may have a shape other than shown in FIG. 3.

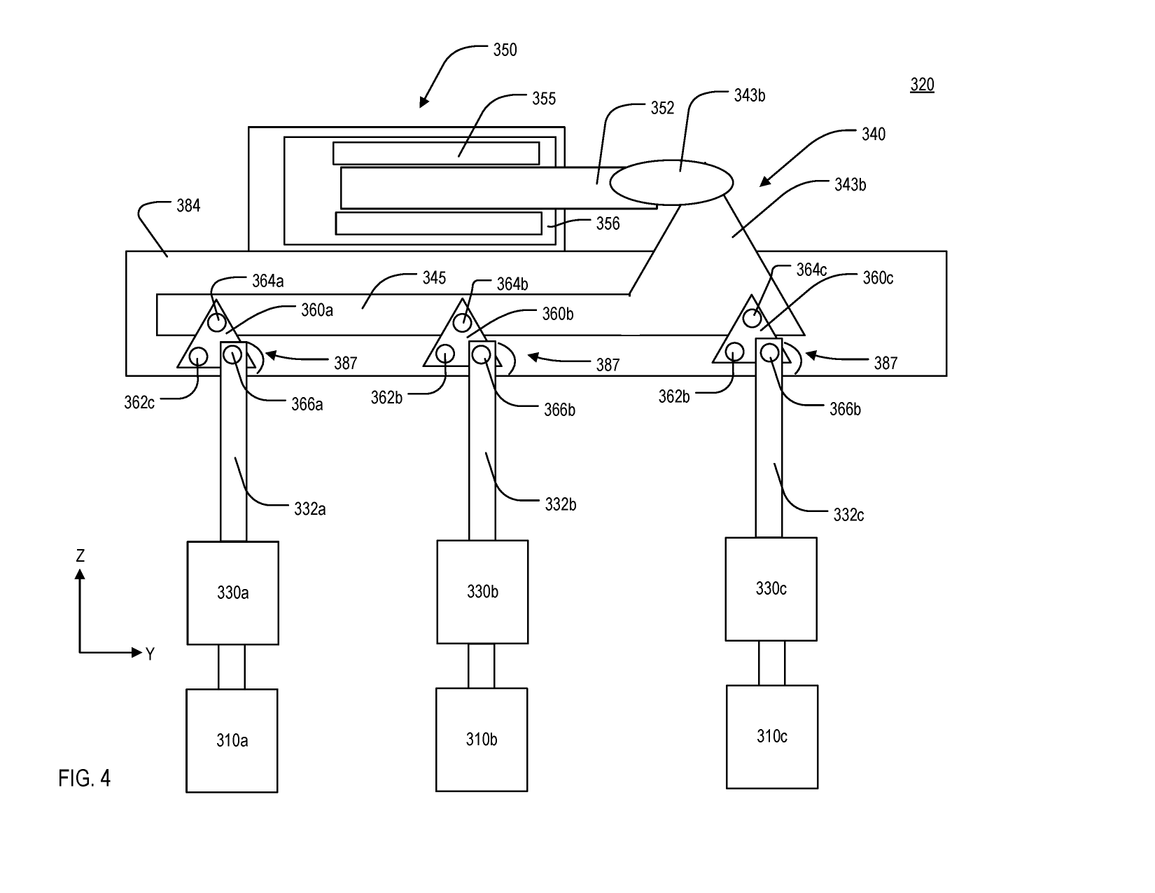

FIG. 4 is a cross-sectional view of the electrical system 320 in the Y-Z plane. The driving apparatus 340 includes a gang bar 345 that extends from the driving plates 342a, 342b generally along the Y axis. The gang bar 345 is attached to crank apparatuses 360a, 360b, 360c at respective moveable pivot points 364a, 364c. 364c. Each crank apparatus 360a, 360b, 360c is attached the frame 380 at a respective fixed pivot point 362a, 362b, 362c. Additionally, each crank apparatus 360a, 360b, 360c includes a respective connection point 366a, 366b, 366c that is coupled to a respective switch operating device 330a, 330b, 330c. The pivot points 364a, 364b, 364c and the connection points 366a, 366b, 366c are not attached to the frame 380 and can move relative to the frame 380.

As discussed above, the electrical system 320 is a three-phase electrical system that includes vacuum interrupters 310a, 310b, 310c, one for each phase. The vacuum interrupters 310a, 310b, 310c are in the closed state in FIG. 4. Each vacuum interrupter 310a, 310b, 310c is associated with a respective switch operating device 330a, 330b, 330c. The actuator 350 is a permanent magnet actuator that includes a coil 355 and permanent magnets 356. When electrical current is applied to the coil 355, the output 352 moves linearly in the Y or -Y direction relative to the bracket 358 and the frame portion 386.

To transition the vacuum interrupters 310a, 310b, 310c to the opened state from the closed state, the actuator 350 is controlled to move the output 352 in the -Y direction, which moves the linkages 343a, 343b and the rigid body formed by the plates 342a, 342b and the gang bar 345 in the -Y direction. Each crank apparatus 360a, 360b, 360c rotates counterclockwise about its respective fixed pivot point 362a, 362b, 362c, causing each connection point 366a, 366b, 366c to move through an arc-shaped slot 387 in the inner main portion 386 and pulling operating rods 332a, 332b, 332c in the Z direction. Moving the operating rods 332a, 332b, 332c in the Z direction opens the vacuum interrupters 310a, 310b, 310c. The vacuum interrupters 310a, 310b, 310c open simultaneously because the linear motion of the gang bar 345 rotates all of the crank apparatuses 360a, 360b, 360c simultaneously. When the vacuum interrupters 310a, 310b, 310c are in the opened state, the gang bar 345 is in a first position.

When the vacuum interrupters 310a, 310b, 310c are opened, operating the actuator 350 such that the output 352 moves in the Y direction closes the vacuum interrupters 310a, 310b, 310c. Specifically, when the output 352 moves in the Y direction, the driving apparatus 340 also moves in the Y direction, which rotates all of the crank apparatuses 360a, 360b, 360c clockwise simultaneously, pushing the operating rods 332a, 332b, 332c in the -Z direction and closing the vacuum interrupters 310a, 310b, 310c. When the vacuum interrupters 310a, 310b, 310c are in the closed state, the gang bar 345 is in a second position.

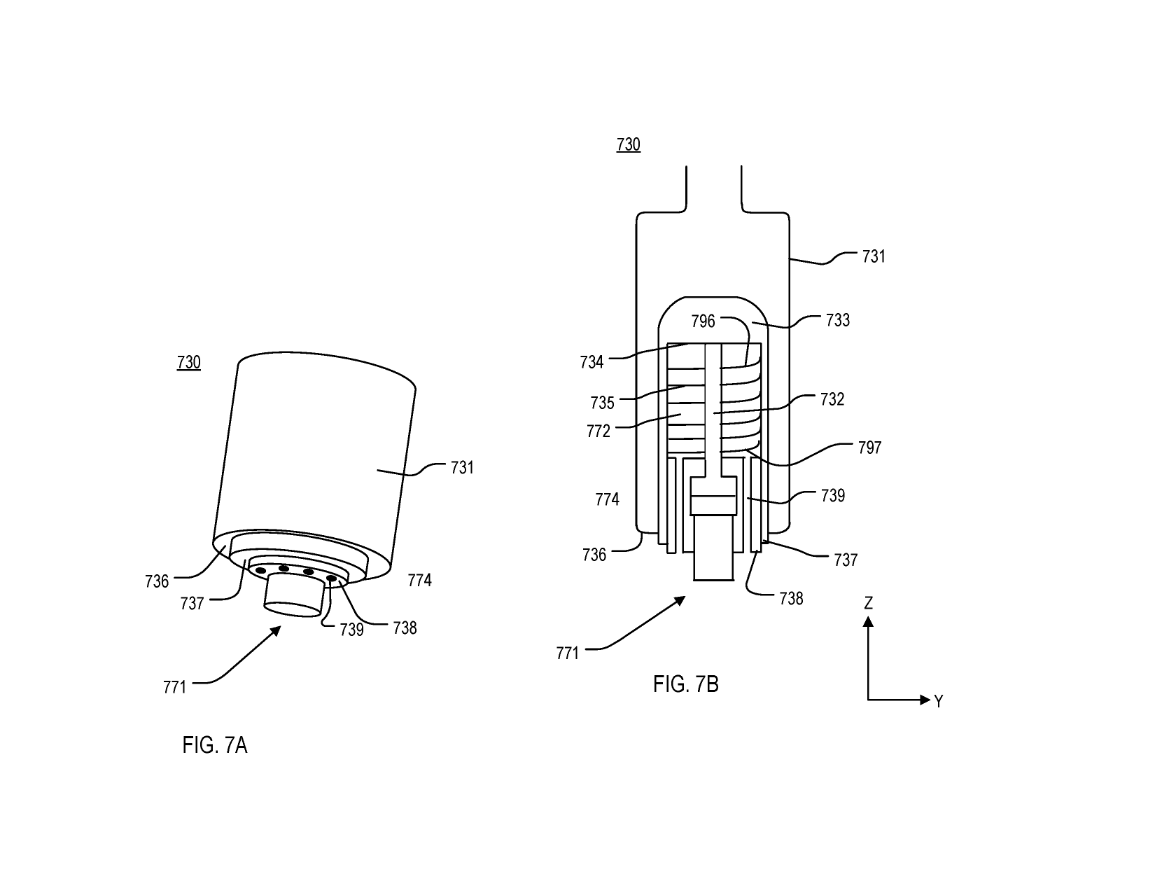

The electrical system 320 may include additional components. For example, the electrical system 320 may include a switching spring (not shown) that is attached to the frame 380 and the plates 342a, 342b. When the actuator 350 closes the vacuum interrupters 310a, 310b, 310c, the switching spring is compressed, the contacts of the vacuum interrupters 310a, 310b, 310c close, and the actuator magnetically latches. In these implementations, upon opening, the magnetic actuator 350 is reverse polarized and unlatches, allowing the switching spring to release its stored energy and drive the contacts of the vacuum interrupters 310a, 310b, 310c open. Moreover, each switch operating device 330a, 330b, 330c may enclose a contact pressure spring (such as shown in FIG. 7B) that is compressed during the close operation and expands during the open operation.

The electrical system 320 may include still other components. For example, the electrical system 320 may include a manual operating handle or other manual interface that allows an operator to open and close the vacuum interrupters 310a, 310b, 310c. In these implementations, the electrical system 320 includes a safety interlock that communicates the state or position of the handle. For example, the handle can be in a “closed” or in an “open/lockout” state. In the open/lockout state, the handle manually opens the vacuum interrupters 310a, 310b, 310c if they are not already opened and then mechanically and electrically locks out the driving apparatus 340 such that vacuum interrupters 310a, 310b, 310c cannot be closed. The safety interlock may include components that are mounted to the frame 380, and the interlock is configured for use at temperatures up to 120ºC.

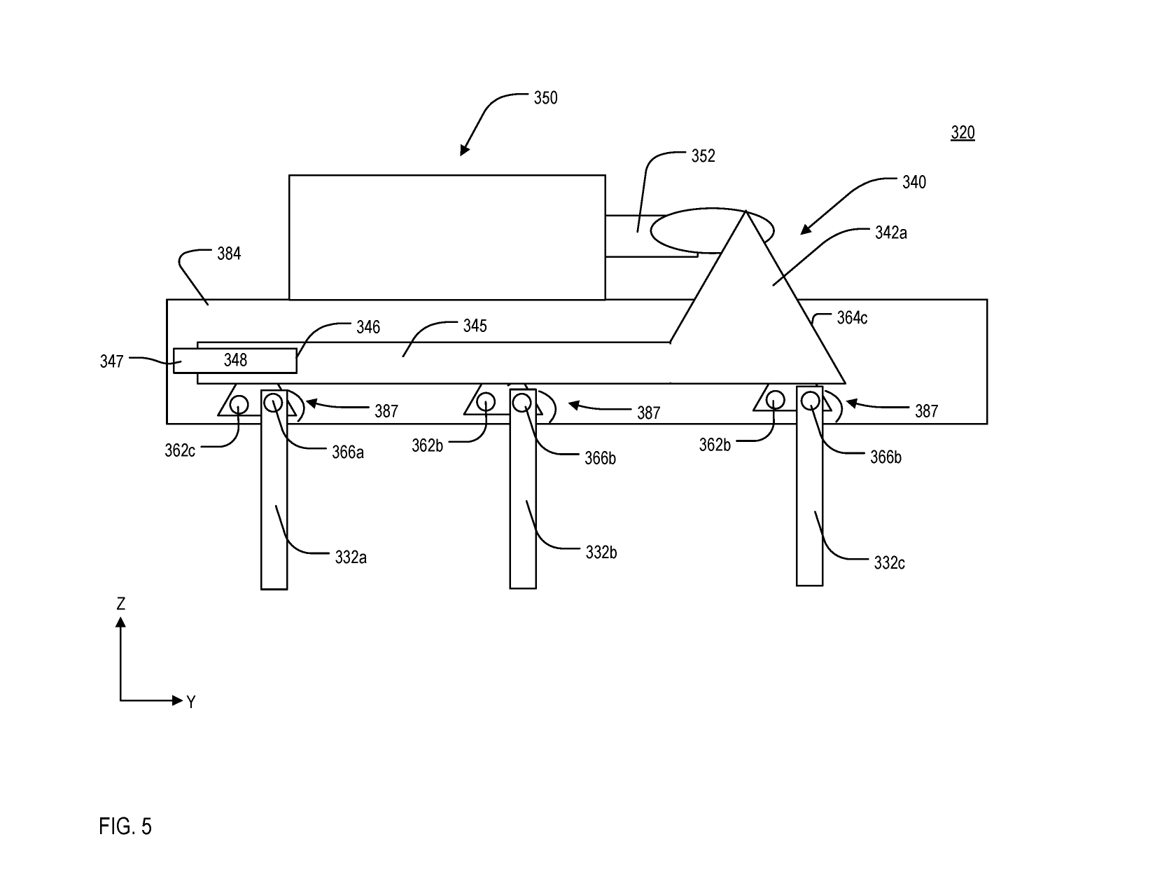

FIG. 5 is a cross-sectional view of part of the electrical system 320. In the view shown in FIG. 5, the plate 342a is visible and the plate 342b is not. A first end 346 of a linear transducer 348 is attached to the gang bar 345 and a second end 347 of the linear transducer 348 is fixedly attached to the frame portion 381 or 384. The first end 346 moves with the gang bar 345 and produces an output (for example, an electrical signal) that represents the position of the moving first end 346 relative to the stationary second end 347. The transducer 348 is configured for operation at temperatures of up to 120ºC.

As discussed above, the gang bar 345 is in the first position when the vacuum interrupters 310a, 310b, 310c are in the opened state and the gang bar 345 moves in the Y direction relative to the frame portions 381, 384 to close the vacuum interrupters 310a, 310b, 310c. By producing a measurement of the position of the moving first end 346, the linear transducer produces an indication of the movement and position of the gang bar 345 relative to the frame portions 381, 384. The position of the gang bar 345 relative to the frame portion 386 is an indication of the state of the vacuum interrupters 310a, 310b, 310c. Thus, the linear transducer 348 provides an indication of the state of the vacuum interrupters 310a, 310b, 310c. The indication may be provided to a control system, an electronic processor, or used to drive a visible indicator to provide a visual or otherwise observable indication of the state of the vacuum interrupters 310a, 310b, 310c.

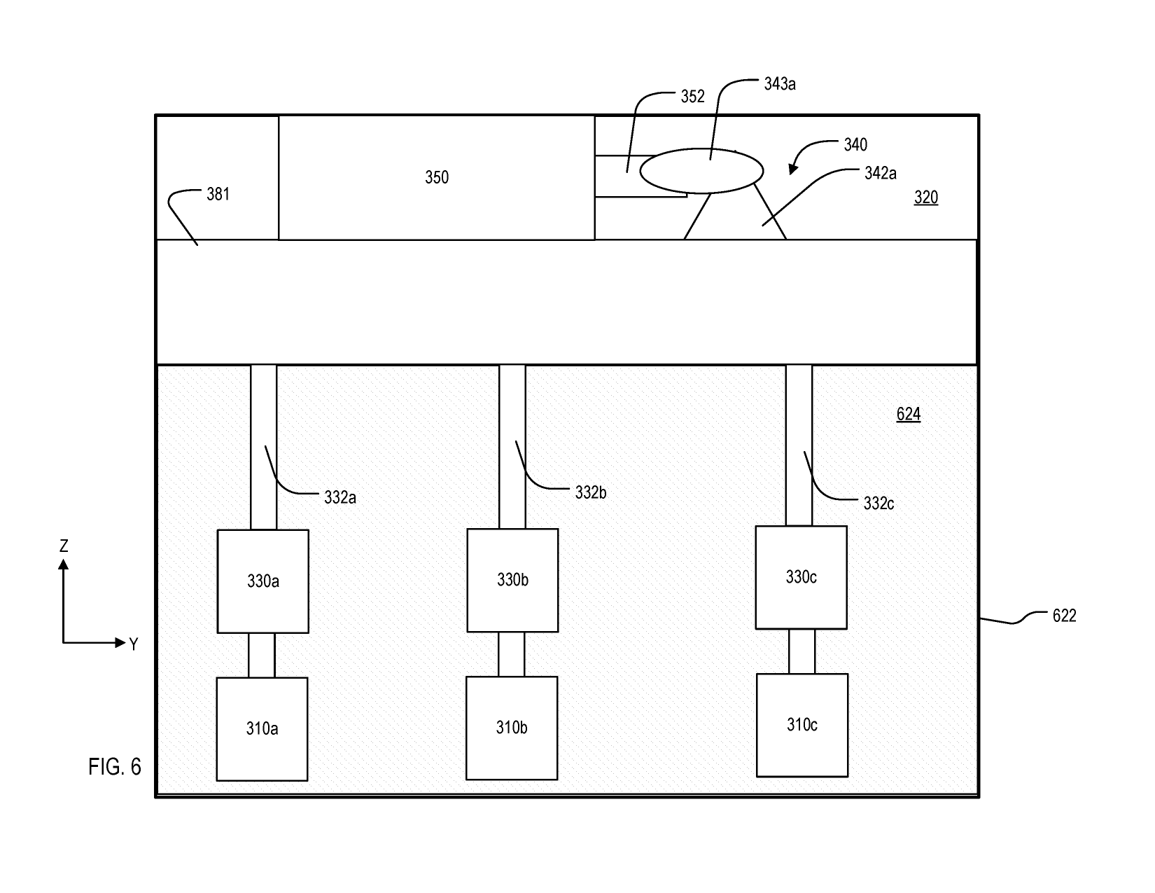

FIG. 6 is a cross-sectional view of the electrical system 320 enclosed in a fluidly sealed housing 622. The housing 622 contains an electrically insulating fluid 624 (shown with diagonal gray shading in FIG. 6). The fluid 624 is any type of electrically insulating fluid. Examples of the fluid 624 include, without limitation, mineral oil, transformer oil, water, switchgear oil, ester-based liquids, and vegetable oil. The vacuum interrupters 310a, 310b, 310c and the switch operating devices 330a, 330b, 330c are submerged in the electrically insulating fluid 624. The frame 380 is not submerged in the fluid 624.

FIG. 7A is a partial exterior perspective view of an end 771 of a switch operating device 730. In implementations in which the electrical system 320 is used with an electrically insulating fluid (such as shown in FIG. 6), each of the switch operating devices 330a, 330b, 330c may be an instance of the switch operating device 730. FIG. 7B is a cross-sectional view of the switch operating device 730 in the Y-Z plane. The switch operating device 730 includes an exterior housing 731 that has an open end 736 and an insert 733 received in the open end 736. The insert 733 may be, for example, a solid steel body. The insert 733 includes an open end 737 that receives an end piece 738. The insert 733 defines a wall 734 that extends in the X-Z plane and an open region 772 between the wall 734 and the end piece 738. An operating rod 732 extends through a first end 773 of the housing 731 and into the open region 772.

The switch operating device 730 also includes a compressible element 735 in the open region 772, and the compressible element 735 surrounds the operating rod 732. The compressible element 735 has a first end 796 and a second end 797. The first end 796 is at the wall 734 and the second end 797 is at an end of the end piece 738. The compressible element 735 may be a spring and may be referred to as a contact pressure spring.

The end piece 738 includes openings 739 that extend through the end piece 738 generally in the Z direction. The openings 739 fluidly couple the open region 772 and a region 774 that is outside of the switch operating device 730. Thus, when used in a system such as shown in FIG. 6, the electrically insulating fluid 624 enters the open region 772 through the openings 739 and the fluid 624 leaves the open region 772 through the openings 739. The other interfaces of the switch operating device 730 are sealed, and the fluid 624 only enters the open region 772 through the openings 739. Four openings 739 are shown in FIG. 7A, but the end piece 738 may include more or fewer openings 739.

The openings 739 improve the operation of the switch operating device 730 and the system in which the device 730 is used. Circuit breakers and vacuum fault interrupters include a contact pressure spring between the mechanism that delivers the motion and the pressure to the moveable rod of the switch. In the switch operating device 730, the compressible element 735 acts as the contact pressure spring. A “mass ratio” is defined as the ratio of M1 (mass on the mechanism side or first end 796 of the contact pressure spring 735) and M2 (mass on the vacuum contact side or second end 797 of the contact pressure). A larger mass ratio generally indicates that opening the switch to interrupt a fault is relatively easier. However, too high of mass ratio may sacrifice mechanical endurance, shortening the lifetime of the switch. If M2 (the mass on the vacuum contact side) is large, then in order to achieve a higher mass ratio, M1 (the mass on the mechanism side) has to be even bigger than M2, leading to a large overall device that is not practical for many applications.

To make a compact and lightweight design, the mass M2 should be kept small. The proximity of the contact pressure spring 735 to the top of the vacuum bottle allows the mass M2 to be minimized. In other words, putting the contact pressure spring 735 in the switch operating device 730 and near the vacuum interrupter instead of, for example, in a driving mechanism such as the driving mechanism 340, places the contact pressure spring 735 closer to the interrupter such that M2 can be made small. This location results in the switch operating device 730 being immersed in insulating liquid, however the addition of the venting holes 739 allows fluid to move into and out of the 772 cavity. Moreover, the contact pressure spring location and associated operating rod design helps in achieving an overall smaller switch and switch operating device while still being able to interrupt faults of up to 25 kA.

Additionally, vacuum interrupters generally operate at relatively high speeds to clear high-energy faults. In order to achieve rapid opening, the motion of the operating rod 723 is started and stopped over a short time period, which can lead to bouncing of the moveable contact in the vacuum interrupter, and the bouncing can lead to unintended re-striking, re-ignition, and/or premature failure. The openings 739 allow fluid to flow into the open region 772, and the fluid provides dampening of the operating rod motion, thereby extending the life of the vacuum interrupter and improving its fault interrupting performance.

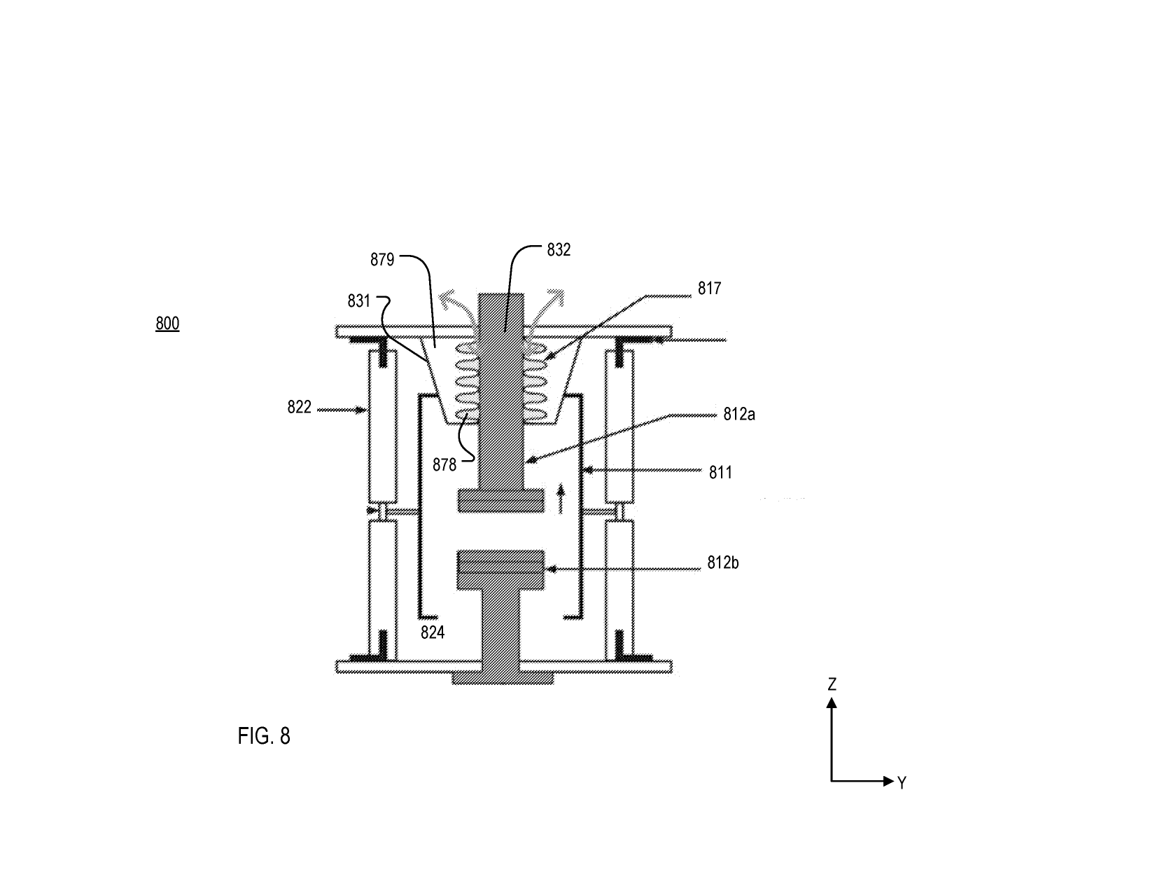

FIG. 8 is a cross-sectional view of a system 800. The system 800 includes a fluidly sealed enclosure 822 that contains an electrically insulating fluid 824 and a vacuum interrupter 810. The vacuum interrupter 810 includes a vacuum bottle 811 that encloses a moveable contact 812a and a stationary contact 812b. The moveable contact 812a is coupled to an operating rod 832 that extends through a switch operating device housing 831 and flexible bellows 817. The bellows 817 compress along the Z axis when the operating rod 823 moves in the Z direction and expand along the Z axis when the operating rod 823 moves in the -Z direction.

The bellows 817 include openings or flutes that allow the fluid 824 to flow from a region 878 to a region 879. The region 878 is between the bellows 817 and the operating rod 832, and the region 879 is between the bellows 817 and the housing 831. The openings in the bellows 817 allow the fluid 824 to be drawn into and expelled from the region 878, thereby providing dampening to the motion of the operating rod 832 and extending the life of the vacuum interrupter.

These and other features are within the scope of the claims.

What is claimed is:

1. A system comprising:
a base;
an actuator mounted to the base, the actuator comprising an output configured to move along a linear path relative to the base;
a driving apparatus coupled to the output; and
a crank apparatus comprising at least one crank device, the at least one crank device comprising: a fixed pivot point attached to the base, a moveable pivot point attached to the driving apparatus, and a connection point attached to a switch operating device, wherein the at least one crank device rotates about the fixed pivot and the moveable pivot moves the driving apparatus relative to the base in response to the output moving along the linear path to control the switch operating device to perform one of an open operation and a close operation in a switch.

2. The system of claim 1, wherein the actuator comprises a permanent magnet actuator.

3. The system of claim 2, wherein the permanent magnet actuator comprises a housing that is mounted to the base and encloses a permanent magnet; and the output is accessible from an exterior of the housing.

4. The system of claim 2, wherein the permanent magnet actuator comprises a neodymium magnet.

5. The system of claim 2, wherein the permanent magnet actuator comprises a magnetic material configured for operation at temperatures between -40 degrees Celsius and 140 degrees Celsius.

6. The system of claim 5, further comprising a linear transducer configured for operation at temperatures between -40 degrees Celsius and 140 degrees Celsius.

7. The system of claim 6, wherein a first end of the linear transducer is fixedly attached to the base and a second end of the linear transducer moves with the driving apparatus, and the linear transducer provides an indication of a position of the driving apparatus.

8. The system of claim 1, further comprising the switch.

9. The system of claim 7, wherein the switch comprises a vacuum interrupter, and the switch operating device comprises a moveable operating rod coupled to a moveable electrical contact of the vacuum interrupter.

10. The system of claim 1, further comprising an operating rod housing that comprises an interior space, wherein the switch operating device extends through a first end of the operating rod housing and into the interior space, and a second end of the operating rod housing defines one or more fluid passageways configure to allow fluid flow between the interior space and a region exterior to the operating rod housing.

11. The system of claim 10, further comprising a contact pressure spring in the interior space, and wherein the contact pressure spring surrounds a portion of the switch operating device.

12. The system of claim 11, wherein the operating rod housing further comprises:
an insert comprising a wall at a first end and an open second end; and
an end block received in the open second end, the end block comprising a first side that faces the first end and a second side that faces away from the first end, and wherein the one or more fluid passageways are openings that extend between the first side of the end block and the second side of the end block, and the contact pressure spring is between the wall and the first side of the end block.

13. The system of claim 1, further comprising an operating rod housing comprising an interior space and a flexible guide bushing, wherein the switch operating device extends through the interior space and the flexible guide bushing surrounds the switch operating device; and the flexible guide bushing comprises one or more openings that allow fluid flow.

14. The system of claim 1, wherein the crank apparatus comprises a plurality of crank devices that rotate simultaneously about their respective pivot points in response to the output moving along the linear path.

15. An operating rod assembly comprising:
a housing that comprises an open end;
an insert in the open end, the insert comprising: a first wall at a first end, a second wall at a second end; and a compressible element in a space between the first wall and the second wall; and
an operating rod configured to be mechanically coupled to a moving contact of a vacuum interrupter, wherein the second wall comprises one or more openings that allow fluid flow between the space and a region exterior to the housing.

16. The operating rod assembly of claim 15, wherein the insert comprises:
a first piece comprising the first wall; and
a second piece received in the first piece, wherein a side of the second piece is the second wall.

17. A transformer apparatus comprising:
a housing comprising an interior region configured to receive an electrically insulating fluid;
a switch in the interior region;
a switch operating device in the interior region, the switch operating device comprising:
one or more openings that fluidly couple the interior region of the housing to an interior region of the switch operating device; and
a compressible element in the interior region of the switch operating device; and
an operating apparatus comprising:
a base;
a permanent magnet actuator mounted to the base, the permanent magnet actuator comprising an output configured to move along a linear path relative to the base;
a driving apparatus coupled to the output; and
a crank apparatus comprising at least one crank device, the at least one crank device comprising: a fixed pivot point attached to the base, a moveable pivot point attached to the driving apparatus, and a connection point attached to the switch operating device, wherein the at least one crank device rotates about the fixed pivot and the moveable pivot moves the driving apparatus relative to the base in response to the output moving along the linear path to control the switch operating device to perform one of an open operation and a close operation in the switch.

18. The transformer apparatus of claim 17, wherein the switch is a vacuum fault interrupter.
